(19) United States
(12) Patent Application Publication
(10) Pub. No.: US 2024/0303382 A1
(43) Pub. Date: Sep. 12, 2024

(54) METHOD, APPARATUS AND SYSTEM FOR MONITORING I2C, AND STORAGE MEDIUM

(71) Applicant: INSPUR SUZHOU INTELLIGENT TECHNOLOGY CO., LTD., Jiangsu (CN)

(72) Inventor: Dong LIU, Suzhou, Jiangsu (CN)

(73) Assignee: INSPUR SUZHOU INTELLIGENT TECHNOLOGY CO., LTD., Suzhou, Jiangsu (CN)

(21) Appl. No.: 18/260,752

(22) PCT Filed: Dec. 31, 2021
(86) PCT No.: PCT/CN2021/143865

§ 371 Date: Jul. 7, 2023

(30) Foreign Application Priority Data
Jan. 11, 2021 (CN) 202110032810.5

(51) Int. Cl. G06F 21/85; G06F 13/42

(52) U.S. Cl. CPC G06F 21/85; G06F 13/4282; G06F 2213/0016

(57) ABSTRACT

The present disclosure relates to the field of computer technologies, in particular to a method, an apparatus, and a system for monitoring an I2C, and a storage medium. The method includes: obtaining a first command from a BMC; recognizing a level of the first command according to a pre-stored command level list, where the level includes a first level, a second level, and a third level, a security level of the third level is higher than a security level of the second level, and the security level of the second level is higher than a security level of the first level; and sending the first command to a device in different modes according to the level of the first command.

### CROSS-REFERENCE TO RELATED APPLICATION

The present application is a National Stage Application of PCT International Application No. PCT/CN2021/143865 filed on Dec. 31, 2021, which claims the priority of Chinese patent application No. 202110032810.5, filed with China National Intellectual Property Administration on Jan. 11, 2021 and entitled “METHOD, APPARATUS AND SYSTEM FOR MONITORING I2C, AND STORAGE MEDIUM”, the entire contents of which are incorporated herein by reference.

### TECHNICAL FIELD

The present disclosure relates to the field of computer technologies, in particular to a method, an apparatus, and a system for monitoring an I2C, and a storage medium.

### BACKGROUND

At present, an inter-integrated circuit (IIC or I2C for short) is widely used in a server management architecture. Data transmission communication is carried out between devices such as a power supply unit (PSU), a hard disk backboard, a temperature sensor, various power VRs, and a complex programmable logic device (CPLD) of a mainboard, and a main chip, namely, a baseboard management controller (BMC) managed by a server by the I2C.

For each device connected to the I2C, the BMC can conveniently and easily obtain device information and control the device. The server is a high-reliability device, so that if the operation of each device is abnormally modified, serious consequences will be brought. For example, the illegal operation such as abnormal shutdown may lead to malignant consequences of data loss, and illegal intrusion and information stealing for the BMC may even lead to information security issues.

Therefore, how to enhance the security of I2C communication is currently an urgent technical problem to be solved.

### SUMMARY

Embodiments of the present disclosure provide a method, an apparatus, and a system for monitoring an I2C, and a storage medium.

In a first aspect, an embodiment of the present disclosure provides a method for monitoring an I2C, the method includes:
a first command is obtained from a BMC;
a level of the first command is recognized according to a pre-stored command level list, wherein the level includes a first level, a second level, and a third level, a security level of the third level is higher than a security level of the second level, and the security level of the second level is higher than a security level of the first level; and the first command is sent to a device in different modes according to the level of the first command.

In some embodiments, before the first command is obtained from a BMC, the method further includes:
a second command is obtained from the device and the second command is sent to the BMC, wherein the second command corresponds to the first command, so that the BMC determines the level of the first command according to the second command;
the level of the first command is received; and
the command level list is generated according to the level of the first command.

In some embodiments, the first command is sent to the device in the different modes according to the level of the first command includes:
a sending mode parameter of the first command is read from the command level list according to the level of the first command; and
the first command is sent to the device according to the sending mode parameter of the first command.

In some embodiments, the sending mode parameter of the first command is read from the command level list according to the level of the first command includes:
in a case that the level of the first command is the first level, the sending mode parameter of the first command is read from the command level list, and a first preset parameter is obtained;
the first command is sent to the device according to the sending mode parameter of the first command includes:
the first command is directly sent to the device according to the first preset parameter.

In some embodiments, the sending mode parameter of the first command is read from the command level list according to the level of the first command includes:
in a case that the level of the first command is the second level, the sending mode parameter of the first command is read from the command level list, and a second preset parameter is obtained;
the first command is sent to the device according to the sending mode parameter of the first command includes:
the first command is returned to the BMC according to the second preset parameter, so that the BMC outputs first prompt information according to the first command;
first reply information sent by the BMC is received according to the first prompt information;
in a case that the first reply information meets a preset condition, the sending mode parameter of the first command is modified to the first preset parameter; and
the first command is directly sent to the device according to the first preset parameter.

In some embodiments, the sending mode parameter of the first command is read from the command level list according to the level of the first command includes:
in a case that the level of the first command is the third level, the sending mode parameter of the first command is read from the command level list, and a second preset parameter is obtained;
the first command is sent to the device according to the sending mode parameter of the first command includes:
the first command is returned to the BMC according to the second preset parameter, so that the BMC outputs second prompt information according to the first command;
turn-on information of a security setting jumper and second reply information sent by the BMC according to the second prompt information are received, wherein the security setting jumper is initially in a turn-off state;
in a case that the second reply information meets a preset condition, the sending mode parameter of the first command is modified to the first preset parameter; and
the first command is directly sent to the device according to the first preset parameter and the turn-on information of the security setting jumper.

In some embodiments, the security setting jumper is a jumper of the device.

Based on a same inventive concept, in a second aspect, the present disclosure further provides an apparatus for monitoring an I2C, the apparatus includes:
a first obtaining component, configured to obtain a first command from a BMC;
a recognition component, configured to recognize a level of the first command according to a pre-stored command level list, where the level includes a first level, a second level, and a third level,
a security level of the third level is higher than a security level of the second level, and the security level of the second level is higher than a security level of the first level; and
a sending component, configured to send the first command to a device in different modes according to the level of the first command.

In some embodiments, the apparatus further includes:
a second obtaining component, configured to obtain a second command from the device and to send the second command to the BMC, where the second command corresponds to the first command, so that the BMC determines the level of the first command according to the second command;
a receiving component, configured to receive the level of the first command; and
a generation component, configured to generate the command level list according to the level of the first command.

Based on a same inventive concept, in a third aspect, the present disclosure provides a system for monitoring an I2C, the system including an I2C, a BMC, a CPLD, a device, and an executable program stored on the CPLD, where the CPLD is connected to the BMC and the device by the I2C, respectively, and the CPLD, when executing the program, implements steps of a method for monitoring an I2C.

Based on a same inventive concept, in a fourth aspect, the present disclosure provides a computer-readable storage medium, having a computer program stored thereon, where the program, when executed by a processor, implements the steps of the above method for monitoring an I2C.

### BRIEF DESCRIPTION OF THE DRAWINGS

Upon reading the detailed description of the preferred embodiments below, various other advantages and benefits will become clear to those of ordinary skill in the art. The accompanying drawings are only intended to illustrate the preferred embodiments and are not considered as a limitation to the present disclosure. Moreover, in the entire drawings, the same reference graphs are used to represent the same components. In the drawings:

FIG. 1 shows a schematic flowchart of steps of a method for monitoring an I2C in Embodiment 1 of the present disclosure;

FIG. 2 shows a schematic diagram of structural connection of a CPLD in Embodiment 1 of the present disclosure;

FIG. 3 shows a schematic diagram of transmission of a command of a first level in Embodiment 1 of the present disclosure;

FIG. 4 shows a schematic diagram of transmission of a command of a second level or a third level in Embodiment 1 of the present disclosure; and

FIG. 5 shows a schematic diagram of components of an apparatus for monitoring an I2C in Embodiment 2 of the present disclosure.

### DETAILED DESCRIPTION OF THE EMBODIMENTS

Exemplary embodiments of the present disclosure will be described in more detail below with reference to the accompanying drawings. Although exemplary embodiments of the present disclosure are shown in the accompanying drawings, it should be understood that the present disclosure may be implemented in various forms and should not be limited by the embodiments described herein. On the contrary, these embodiments are provided to understand the present disclosure more thoroughly and to convey the scope of the present disclosure to those skilled in the art completely.

### Embodiment 1

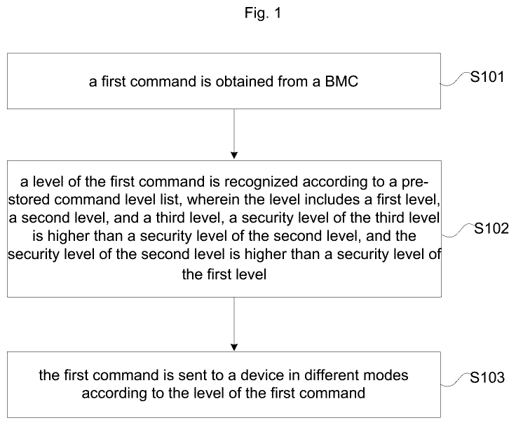

A first embodiment of the present disclosure provides a method for monitoring an I2C, as shown in FIG. 1, the method including:
S101: a first command is obtained from a BMC;
S102: a level of the first command is recognized according to a pre-stored command level list, wherein the level includes a first level, a second level, and a third level, a security level of the third level is higher than a security level of the second level, and the security level of the second level is higher than a security level of the first level; and
S103: the first command is sent to a device in different modes according to the level of the first command.

The present disclosure provides a method for monitoring an I2C. In hardware design, the CPLD is embedded between the BMC and the device to monitor the commands. The method is applied to the CPLD. The CPLD divides the commands into those of three different security levels, and a different sending mode is adopted for the command of each level. Moreover, the command level list is used to record sending modes corresponding to the commands of the different levels, so as to ensure the security of I2C communication. Also, the advantages of simple operation, convenience, practicality and the like are achieved.

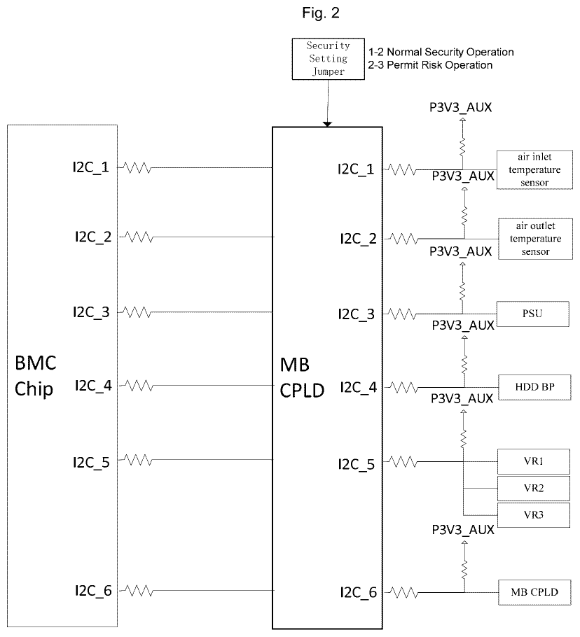

It should be noted that the method according to the present disclosure is applied to a CPLD. As shown in FIG. 2, the CPLD is connected at one end to the BMC and at the other end to each device 203 by the I2C. In practical applications, both the BMC and the CPLD belong to important chips on a mainboard. However, under normal circumstances, the CPLD is not connected between the device and the BMC, while a level of CPLD is directly added between the device and the BMC, namely, the chip in the present disclosure, so as to implement the method according to the present disclosure. Therefore, the present disclosure features simple structure, convenience, practicality, and low cost.

According to the present disclosure, commands sent by the BMC are divided into those of different security levels, different transmission modes are adopted, and data on the I2C is monitored in real time, which improves the security of I2C communication and provides a guarantee for transmission of the data on the I2C.

In a specific implementation process, before step S101, the method further includes:
a second command is obtained from the device and sending the second command is sent to the BMC, wherein the second command corresponds to the first command, so that the BMC determines the level of the first command according to the second command;
the level of the first command is received; and
the command level list is received according to the level of the first command.

Specifically, before step S101, the CPLD obtains the commands involved in the device and meanings thereof from the device, and sends the commands involved and the meanings thereof to an operator by the BMC, and the operator distinguishes the importance of the commands and sets the corresponding levels of the commands, which are the first level, the second level, and the third level with a gradual increase in security level, respectively, and are recorded as class1, class2, and class3.

Generally, a command of the Class1 is an ordinary register read operation with a higher security level. In term of security, the CPLD allows such operation to run unconditionally.

A command of the Class2 is a register write operation, which will change an operating state of the device, such as a slightly sensitive operation of setting an OCP threshold, setting a temperature threshold, etc.

A command of the Class3 is a sensitive operation of setting the device to be shut down, powered off, reset, restarted, etc., and a direct operation is not allowed by default.

The operator sets the commands and the levels thereof and then input them into the CPLD to generate a command list, so as to provides a basis for dividing the levels of the commands subsequently received by the CPLD. It should be noted that the first command is in a correspondence to the second command, and the correspondence represents that the command applied in the device is consistent with the command sent by the BMC to the device. For example, the command applied in the device A is VIN_ON, which represents a command to read a device voltage threshold of the device A. When the BMC reads the voltage threshold of the device, the voltage threshold of the device A can only be read by sending the command VIN_ON.

In a specific implementation process, step S103 includes:
a sending mode parameter of the first command is read from the command level list according to the level of the first command; and
the first command is sent to the device according to the sending mode parameter of the first command.

Specifically, in the present disclosure, different sending mode parameters are set according to commands of different security levels. Then, the commands are sent to the device according to the different sending mode parameters. The commands, the command levels, and the sending parameters correspond and are all recorded in the command level list, which simplifies the management of the commands and features the practicality.

In a specific implementation process, if the level of the first command is the first level, the sending mode parameter of the first command is read from the command level list, and a first preset parameter is obtained; and the first command is directly sent to the device according to the first preset parameter. If the level of the first command is the second level or the third level, the sending mode parameter of the first command is read from the command level list, and a second preset parameter is obtained; and the first command is not directly sent to the device according to the second preset parameter.

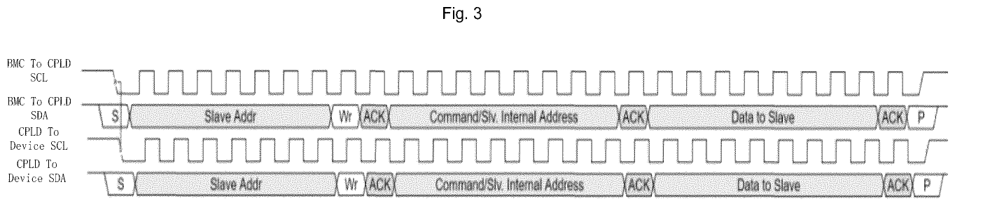

Specifically, when the BMC sends the command to the device, the command is monitored in real time by the CPLD. As shown in Table 1 below, if the command level is the first level, the sending parameter of the command of the first level is the first preset parameter. When the first preset parameter is set to be 1, it indicates that the command is allowed to be sent, and the CPLD directly transmits the command back to the device. A specific data transmission process is as shown in FIG. 3. The CPLD sets a serial clock line (SCL) and a serial data line (SDA) to be in a normal command sending state, and the command sent by the BMC is directly sent to the device.

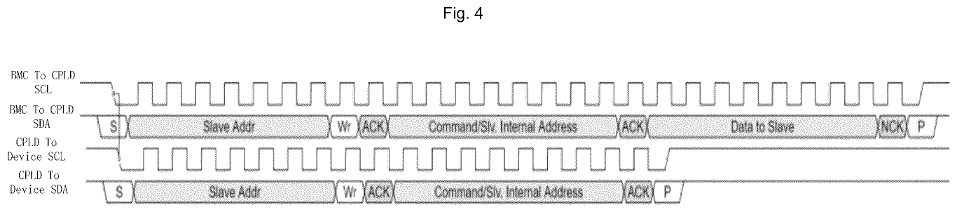

If the command level is the second level or the third level, the sending parameter of the command of the first level is the second preset parameter. When the second preset parameter is set to be 0, it indicates that the command is not allowed to be sent, and the CPLD directly sets a clock signal (i.e. Clock) and a data signal (i.e. Data) of the device to be both at high levels, so as to prevent the command from being transmitted to the device. As shown in FIG. 4, the CPLD directly sets the SCL and the SDA to be at high levels after detecting that the command being transmitted is a command not allowed to be transmitted. Therefore, in the present disclosure, both the serial clock line and the serial data line are directly set to be at the high levels, so as to prevent the command of the second level and the command of the third level from being sent to the device, which enhances the security of I2C communication.

TABLE 1
Command level list

| Command | Level | Sending information |
|---|---|---|
| Command0 | 1 | 1 |
| Command1 | 0 | 2 |
| Command2 | 0 | 3 |
| Command3 | 0 | 3 |
| Command4 | 0 | 2 |
| Command5 | 1 | 1 |
| Command6 | 1 | 1 |
| Command7 | 1 | 1 |
| Command8 | 0 | 3 |
| Command9 | 1 | 1 |

Further, if the level of the first command is the second level, the sending mode parameter of the first command is the second preset parameter;
the first command is returned to the BMC according to the second preset parameter, so that the BMC outputs first prompt information according to the first command;
first reply information sent by the BMC according to the first prompt information is received;
in a case that the first reply information meets a preset condition, the sending mode parameter of the first command is modified to the first preset parameter; and
the first command is directly sent to the device according to the first preset parameter.

Specifically, for the command of the second level, before transmission, the BMC must modify the sending mode parameter of the corresponding command of the second level in the command list by an I2C, and sets the second preset parameter of the command as the first preset parameter representing that the transmission is allowed, that is, modifies “0” in the sending mode parameter to “1”. In this case, the CPLD recognizes a modified sending mode parameter of the command and immediately sends the command. The operation of setting and modifying the sending mode parameters in the command level list and the operation of modification required before sending of the command of the second level are intended to enhance the security. Even if an illegal user obtains a control right of the BMC, the related commands cannot be transmitted into the device if the sending mode parameters are not modified.

To further enhance the security, the sending mode parameters automatically restore to initial values thereof in 60 s or other preset time after being modified. In this case, the sending mode parameter needs to be re-modified for sending the command of the second level. The initial values of the sending mode parameters are initial set values of the sending mode parameters in the command level list. For example, in the command level list, the initial set value of the sending mode parameter of the command of the second level is the second preset parameter, which is “0”. To successfully send the command of the second level, the sending mode parameter thereof needs to be modified to the first preset parameter, which is “1”. This modification is valid for 60 s. The sending mode parameter of the command of the second level automatically restores to the second preset parameter “0” in 60 s.

Further, in a case that the level of the first command is the third level, the sending mode parameter of the first command is the second preset parameter;
the first command is returned to the BMC according to the second preset parameter, so that the BMC outputs second prompt information according to the first command;
turn-on information of a security setting jumper and second reply information sent by the BMC according to the second prompt information are received, wherein the security setting jumper is initially in a turn-off state;
in a case that the second reply information meets a preset condition, the sending mode parameter of the first command is modified to the first preset parameter; and
the first command is directly sent to the device according to the first preset parameter and the turn-on information of the security setting jumper.

Specifically, the command of the third level is more sensitive and does not need to be triggered during normal command sending. To ensure the security, transmission conditions for the command of the third level are set more strictly. In addition to the need to modify the sending mode parameter (the operation of modifying the sending mode parameter is the same as that of modifying the sending mode parameter of the command of the second level, and will not be repeated herein), the security setting jumper needs to be set to be in a turn-on state in hardware. Therefore, the command of the third level cannot be transmitted without modifying the hardware.

To further enhance the security, the sending mode parameters automatically restore to initial values thereof in 60 s or other preset time after being modified. In this case, the sending mode parameter needs to be re-modified for sending the command of the third level.

In some embodiments, the security setting jumper represents a jumper of the device.

It should be noted that in a computer, the jumper refers to springs for a pair of electrical contacts on a computer mainboard or an adapter card. When one jumper is arranged, one plug is inserted onto two springs, so that the springs are in contact with each other. In fact, the jumper functions like a switch and is used to turn off (or turn on) a circuit. The function or performance of a PC component can be changed by adding or removing the jumper. A group of jumpers is called a jumper block.

One or more technical solutions in the embodiments of the present disclosure have at least the following technical effects or advantages:
1. In the embodiments of the present disclosure, the CPLD on the mainboard is used to enhance the security of I2C communication. The present disclosure has the advantages of simple structure, practical operation, lower cost and the like.
2. In the embodiments of the present disclosure, different commands are divided based on different levels of security coefficients, and then different data transmission modes are set according to the different levels, which enhances the security of I2C communication.
3. In the embodiments of the present disclosure, the command of the second level uses sending information that must be modified, it is required to modify sending information and turn on the jumper for the command of the third level, and I2C communication operations with corresponding security coefficients are set for commands with different security coefficients, which ensures the security of I2C communication.

### Embodiment 2

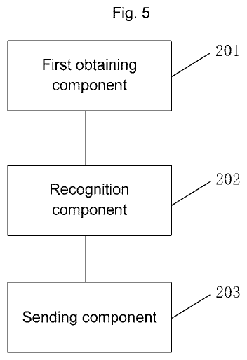

Based on a same inventive concept, a second embodiment of the present disclosure further provides an apparatus for monitoring an I2C, as shown in FIG. 5, the apparatus includes:
a first obtaining component 201, configured to obtain a first command from a BMC;
a recognition component 202, configured to recognize a level of the first command according to a pre-stored command level list, where the level includes a first level, a second level, and a third level, a security level of the third level is higher than a security level of the second level, and the security level of the second level is higher than a security level of the first level; and a sending component 203, configured to send the first command to a device in different modes according to the level of the first command.

In some embodiments, the apparatus further includes:
a second obtaining component, configured to obtain a second command from the device and to send the second command to the BMC, where the second command corresponds to the first command, so that the BMC determines the level of the first command according to the second command;
a receiving component, configured to receive the level of the first command; and
a generation component, configured to generate the command level list according to the level of the first command.

In some embodiments, the sending component 203 is further configured to: read a sending mode parameter of the first command from the command level list according to the level of the first command; and
send the first command to the device according to the sending mode parameter of the first command.

In some embodiments, the reading a sending mode parameter of the first command from the command level list according to the level of the first command includes: if the level of the first command is the first level, reading the first command from the command level list, and obtaining a first preset parameter;
the sending the first command to the device according to the sending mode parameter of the first command includes: directly sending the first command to the device according to the first preset parameter.

In some embodiments, the reading a sending mode parameter of the first command from the command level list according to the level of the first command includes: if the level of the first command is the second level, reading the first command from the command level list, and obtaining a second preset parameter;
the sending the first command to the device according to the sending mode parameter of the first command includes:

returning the first command to the BMC according to the second preset parameter, so that the BMC outputs first prompt information according to the first command;
receiving first reply information sent by the BMC according to the first prompt information;
if the first reply information meets a preset condition, modifying the sending mode parameter of the first command to the first preset parameter; and
directly sending the first command to the device according to the first preset parameter.

In some embodiments, the reading a sending mode parameter of the first command from the command level list according to the level of the first command includes: if the level of the first command is the third level, reading the first command from the command level list, and obtaining a second preset parameter;
the sending the first command to the device according to the sending mode parameter of the first command includes:
returning the first command to the BMC according to the second preset parameter, so that the BMC outputs second prompt information according to the first command;
receiving turn-on information of a security setting jumper and second reply information sent by the BMC according to the second prompt information, where the security setting jumper is initially in a turn-off state;
if the second reply information meets a preset condition, modifying the sending mode parameter of the first command to the first preset parameter; and
directly sending the first command to the device according to the first preset parameter and the turn-on information of the security setting jumper.

The apparatus for monitoring an I2C introduced in this embodiment is the apparatus used to implement the method for monitoring an I2C in Embodiment 1 of the present application, so that based on the method for monitoring an I2C introduced in Embodiment 1 of the present application, those skilled in the art can understand the specific embodiment and various variations of the apparatus for monitoring an I2C in this embodiment. Therefore, how to implement the method in Embodiment 1 of the present application by the apparatus for monitoring an I2C will not be introduced in detail herein. All of the apparatuses used by those skilled in the art to implement the method for monitoring an I2C in Embodiment 1 of the present application fall within the scope of protection of the present application.

### Embodiment 3

Based on a same inventive concept, a third aspect embodiment of the present disclosure provides a system for monitoring an I2C, as shown in FIG. 2, the system including an I2C, a BMC, a CPLD, a device, and an executable program stored on the CPLD, where the CPLD is connected to the BMC and the device by the I2C, respectively, and the CPLD, when executing the program, implements any one of the steps in the method for monitoring an I2C in Embodiment 1.

### Embodiment 4

Based on a same inventive concept, a fourth embodiment of the present disclosure provides a computer-readable storage medium, having a computer program stored thereon, where the program, when executed by a processor, implements the steps of any one of the above methods for monitoring an I2C in Embodiment 1.

The algorithms and displays provided herein are not inherently related to any specific computer, virtual system or other device. Various general-purpose systems may also be used with the demonstration teaching herein. According to the above description, the structure required to construct such system is obvious. In addition, the present disclosure is not specific to any specific programming language. It should be understood that the content of the present disclosure described herein can be implemented using various programming languages, and the above description of specific languages is for the purpose of disclosing the optimal embodiment of the present disclosure.

A large number of specific details are described in the specification provided herein. However, it can be understood that the embodiments of the present disclosure can be practiced without these specific details. In some examples, well-known methods, structures and technologies are not shown in detail, to avoid blurring the understanding of this specification.

Similarly, it should be understood that, to simplify the present disclosure and assist in understanding one or more of various aspects of the invention, in the above description of exemplary embodiments of the present disclosure, various features of the present disclosure are sometimes grouped together into a single embodiment, a diagram, or a description thereof. However, the disclosed method should not be interpreted as reflecting the following intention: the present disclosure to be claimed requires more features than explicitly described in each claim. More precisely, as reflected in the following claims, the invention has features fewer than all features the single embodiment disclosed previously. Therefore, the claims following specific embodiments are explicitly incorporated into the specific embodiments, where each claim itself serves as an individual embodiment of the present disclosure.

Those skilled in the art can understand that the components of the device in an embodiment can be adaptively changed and arranged in one or more devices different from the embodiment. The components, units or components in the embodiments can be combined into one component, unit or component, and in addition, they can be divided into a plurality of subcomponents, subunits or subcomponents. Except for at least some of such features and/or processes or units that are mutually exclusive, any combination may be used to combine all features disclosed in this specification (including accompanying claims, abstract and drawings) and all processes or units of any method or device so disclosed. Each feature disclosed in this specification (including accompanying claims, abstract and drawings) may be substituted by an alternative feature that provides the same, equivalent or similar purpose, unless otherwise explicitly stated.

In addition, those skilled in the art can understand that although some embodiments herein include certain features included in other embodiments rather than other features, combinations of features of different embodiments mean being within the scope of the present disclosure and forming the different embodiments. For example, in the following claims, any one of the embodiments to be claimed may be used in any combination.

Various component embodiments of the present disclosure may be implemented by hardware, a software component running on one or more processors, or a combination thereof. Those skilled in the art should understand that a microprocessor or a digital signal processor (DSP) may be used in practice to implement some or all functions of some or all components of the BMC, the CPLD, and the device according to the embodiments of the present disclosure. The present disclosure may also be implemented as a device or apparatus program (such as a computer program and a computer program product) for performing part or all of the method described herein. Such program implementing the present disclosure may be stored on the computer-readable medium or may be in the form of one or more signals. Such signals may be downloaded from Internet websites, provided on carrier signals, or provided in any other form.

It should be noted that the above embodiments illustrate rather than limiting the present disclosure, and those skilled in the art can design alternative embodiments without departing from the scope of the appended claims. In the claims, any reference symbol located between parentheses should not be constructed as a limitation to the claims. The term “include/comprise” does not exclude the existence of elements or steps not listed in the claims. The term “a/an” or “one” located before an element does not exclude the existence of a plurality of such elements. The present disclosure may be implemented with the aid of hardware including several different elements, and an appropriately programmed computer. In the unit claims that list several apparatuses, several of these apparatuses may be specifically embodied by the same hardware item. The use of the terms “first”, “second”, and “third” does not indicate any order. These terms may be interpreted as names.

1. A method for monitoring an I2C, the method being applied to a complex programmable logic device (CPLD), the CPLD being connected to a baseboard management controller (BMC) and a device by an inter-integrated circuit (I2C), respectively, the method comprising:
obtaining a first command from the BMC;
recognizing a level of the first command according to a pre-stored command level list, wherein the level comprises a first level, a second level, and a third level, a security level of the third level is higher than a security level of the second level, and the security level of the second level is higher than a security level of the first level; and
sending the first command to the device in different modes according to the level of the first command.

2. The method according to claim 1, wherein before obtaining the first command from the BMC, the method further comprises:
obtaining a second command from the device and sending the second command to the BMC, wherein the second command corresponds to the first command, so that the BMC determines the level of the first command according to the second command;
receiving the level of the first command; and
generating the command level list according to the level of the first command.

3. The method according to claim 1, wherein sending the first command to the device in the different modes according to the level of the first command comprises:
reading a sending mode parameter of the first command from the command level list according to the level of the first command; and
sending the first command to the device according to the sending mode parameter of the first command.

4. The method according to claim 3, wherein reading the sending mode parameter of the first command from the command level list according to the level of the first command comprises:
in a case that the level of the first command is the first level, reading the sending mode parameter of the first command from the command level list, and obtaining a first preset parameter;
sending the first command to the device according to the sending mode parameter of the first command comprises:
directly sending the first command to the device according to the first preset parameter.

5. The method according to claim 3, wherein reading the sending mode parameter of the first command from the command level list according to the level of the first command comprises:
in a case that the level of the first command is the second level, reading the sending mode parameter of the first command from the command level list, and obtaining a second preset parameter;
sending the first command to the device according to the sending mode parameter of the first command comprises:
returning the first command to the BMC according to the second preset parameter, so that the BMC outputs first prompt information according to the first command;
receiving first reply information sent by the BMC according to the first prompt information;
in a case that the first reply information meets a preset condition, modifying the sending mode parameter of the first command to the first preset parameter; and
directly sending the first command to the device according to the first preset parameter.

6. The method according to claim 3, wherein reading the sending mode parameter of the first command from the command level list according to the level of the first command comprises:
in a case that the level of the first command is the third level, reading the sending mode parameter of the first command from the command level list, and obtaining a second preset parameter;
sending the first command to the device according to the sending mode parameter of the first command comprises:
returning the first command to the BMC according to the second preset parameter, so that the BMC outputs second prompt information according to the first command;
receiving turn-on information of a security setting jumper and second reply information sent by the BMC according to the second prompt information, wherein the security setting jumper is initially in a turn-off state;
in a case that the second reply information meets a preset condition, modifying the sending mode parameter of the first command to the first preset parameter; and
directly sending the first command to the device according to the first preset parameter and the turn-on information of the security setting jumper.

7-8. (canceled)

9. A system for monitoring an I2C, the system comprising:
an inter-integrated circuit (I2C), a baseboard management controller (BMC), a complex programmable logic device (CPLD), a device, and an executable program stored on the CPLD, wherein the CPLD is connected to the BMC and the device by the I2C, when the program is executed by the CPLD, the CPLD is enabled to:
obtain a first command from the BMC;
recognize a level of the first command according to a pre-stored command level list, wherein the level comprises a first level, a second level, and a third level, a security level of the third level is higher than a security level of the second level, and the security level of the second level is higher than a security level of the first level; and
send the first command to the device in different modes according to the level of the first command.

10. A computer-readable storage medium, having a computer program stored thereon, wherein when the computer program is executed by the one or more processors, the one or more processors are enabled to: obtain a first command from the BMC;
recognize a level of the first command according to a pre-stored command level list, wherein the level comprises a first level, a second level, and a third level, a security level of the third level is higher than a security level of the second level, and the security level of the second level is higher than a security level of the first level; and
send the first command to the device in different modes according to the level of the first command.

11. The method according to claim 1, wherein, a command of the first level is an ordinary register read operation.

12. The method according to claim 1, wherein, a command of the second level is a register write operation, which configured to change an operating state of the device.

13. The method according to claim 1, wherein, a command of the third level is a sensitive operation which includes at least one of the following: setting the device to be shut down, setting the device to be powered off, setting the device to be reset, and setting the device to be restarted.

14. The method according to claim 3, wherein, different sending mode parameters are set according to commands of different security levels.

15. The method according to claim 4, wherein, when the BMC sends the first command to the device, the first command is monitored in real time by the CPLD.

16. The method according to claim 4, wherein, when the first preset parameter is set to be 1, which indicates that the first command is allowed to be sent, the CPLD directly transmits the first command back to the device.

17. The method according to claim 5, wherein, when the second preset parameter is set to be 0, which indicates that the command is not allowed to be sent, the CPLD directly sets a clock signal and a data signal of the device to be both at high levels, so as to prevent the command from being transmitted to the device.

18. The method according to claim 5, wherein modifying the sending mode parameter of the first command to the first preset parameter comprises:
when the sending mode parameter is set to be 0, modifying the sending mode parameter to 1.

19. The method according to claim 5, wherein reading the sending mode parameter of the first command from the command level list according to the level of the first command further comprises:
in a case that the sending mode parameter automatically restore to initial value thereof in preset time after being modified, re-modifying the sending mode parameter for sending the first command of the second level.

20. The method according to claim 19, wherein the initial value of the sending mode parameter is initial set value of the sending mode parameter in the command level list.

21. The method according to claim 6, wherein reading the sending mode parameter of the first command from the command level list according to the level of the first command further comprises:
In a case of the sending mode parameter automatically restore to initial value thereof in preset time after being modified, re-modifying the sending mode parameter for sending the first command of the third level.

22. The method according to claim 21, wherein the security setting jumper represents a jumper of the device.
